(19) United States
(12) Patent Application Publication
(10) Pub. No.: US 2011/0223679 A1
(43) Pub. Date: Sep. 15, 2011

(54) METHOD OF SEEKING AT LEAST ONE ANALYTE IN A MEDIUM LIKELY TO CONTAIN IT

(75) Inventors: Jean-Christophe Cau, Colomiers (FR); Helene Lalo, Toulouse (FR); Jean-Pierre Peyrade, Ramonville Saint Agne (FR); Childerick Severac, Toulouse (FR); Christophe Vieu, Auzeville (FR)

(73) Assignees: INNOPSYS, Carbonne (FR); CENTRE NATIONAL DE LA RECHERCHE SCIENTIFIQUE, Paris (FR)

(21) Appl. No.: 13/063,287

(22) PCT Filed: Sep. 10, 2009
(86) PCT No.: PCT/EP2009/061777

§ 371 Date: May 26, 2011

(30) Foreign Application Priority Data
Sep. 11, 2008 (FR) 0856107

(51) Int. Cl. G01N 21/00

(52) U.S. Cl. 436/164; 422/82.05

(57) ABSTRACT

A new method of seeking the presence of an analyte bound to a probe, wherein a periodic geometric pattern (24), constituting a diffractive system (2), is formed by alternating areas including a probe A, and areas not including the probe A. The diffractive system (2) is made to be diffractive before a sensitization step, i.e. a step during which a probe is temporarily brought into contact with a medium likely to contain an analyte and during which the possible analyte binds to the probe. The method includes at least the following steps:
measurement of a power P₁ of a first-order diffraction beam of a diffraction field produced by the diffractive system, with the probe unsensitized,
sensitizing the probe A,
measurement of a power P₁ₐ of a first-order diffraction beam of a diffraction field produced by the diffractive system, and
comparison of the measured powers P₁ and P₁ₐ.

The present invention relates to the field of analyte detection. More specifically, the invention relates to a method of seeking the presence of at least one analyte in a medium likely to contain it.

Determining the presence of biological or organic substances in media is an important step, among others, in diagnosing many diseases.

The methods commonly used for determining this are based on the formation of a specific binding reaction between an analyte, i.e. the substance to be detected, and a complement specific to this analyte, called probe, which is a substance capable of specifically binding the analyte.

Generally, the reaction thus formed is highlighted by a marker associated with the analyte, for example a fluorescent marker.

After placing the probe in contact with the medium likely to contain the analyte, the specific reaction is determined by realizing an excitation of the fluorescent markers, then by detecting the fluorescence light re-emitted by the markers.

In addition to the presence of a marker, however, fluorescence detection requires a negative control of the measurements to determine whether a specific interaction has occurred, i.e. a coupling of the analyte with its complement.

Another way to highlight the reaction formed is by using a diffraction grating.

It is known that when a grating is illuminated by a light source, the light beam is diffracted by the grating and a diffraction pattern is produced. The diffraction field observed depends, among others, on the characteristics of the grating, for example, the period or the thickness of the grating.

U.S. Pat. No. 4,876,208 describes an example of a method for detecting an analyte in a medium likely to contain it. According to the invention, the grating comprising the probe is realized so as to be non-diffractive before being put into contact temporarily with a medium likely to contain the analyte and to be diffractive if there is formation of the specific binding reaction with the analyte. The analyte binding to the probe will alter the characteristics of the grating, its thickness among others, thus creating a diffraction field.

U.S. patent application 2002/0025534 describes a device and method of analyte detection based on the principle described in U.S. Pat. No. 4,876,208. The lithographic technologies used to realize the grating are micrometric in scale, with the grating period being larger than one micrometer. This generates a small angular separation between the different orders of diffracted beams, leading to a complexity in the realization of the detection device. Another disadvantage of the invention is the use of a structured substrate, therefore not flat, which complicates the realization of the grating. Furthermore, the invention describes the possibility of realizing two superimposed gratings allowing the detection of two different analytes. The two gratings each generate a different diffraction field with spatially different diffraction orders. Thus, a specific measurement of each field's diffraction beams is needed to detect the analytes corresponding to each grating.

The present invention proposes a new method of seeking the presence of an analyte bound to a probe, wherein a regular geometric pattern, constituting a diffractive system, is formed by alternating areas comprising a probe, called probe A, and areas not comprising the probe A.

According to the invention, the diffractive system is made to be diffractive before a sensitization step, i.e. a step during which a probe is temporarily brought into contact with a medium likely to contain an analyte and during which the possible analyte binds to the probe, and the method comprises at least the following steps:
a) measurement of a power P₁ of a first-order diffraction beam of a diffraction field produced by the diffractive system, with the probe unsensitized,
b) sensitization of the probe A,
c) measurement of a power P₁ₐ of a first-order diffraction beam of a diffraction field produced by the diffractive system,
d) comparison of the measured powers P₁ and P₁ₐ, said steps being performed in the order listed.

According to the invention, the period p of the periodic geometric pattern is from λ and 2λ, λ corresponding to an illumination wavelength of the diffractive system, such that only the first-order diffracted beam is visible. The lithographic technologies used to realize the geometric pattern are known nanometer-scale technologies.

Preferably, the comparison is performed by determining a relative variation of signal, called sensitivity S, using the formula

$$S = \frac{{P}_{1} - {P}_{1 a}}{{P}_{1}} .$$

The sensitivity S is compared with two threshold values S1 and S2, and
the presence of the analyte on the probe A is signaled if S is greater than S1,
the absence of the analyte on the probe A is signaled if S is less than S2,
an uncertainty as to the presence or absence of the analyte on the probe A is signaled if S is between S1 and S2.

In a particular implementation of the method, step b) also performs the sensitization of a probe B, when the areas of the periodic geometric pattern that do not comprise the probe A essentially comprise the probe B, which is sensitive to an analyte to which the probe A is not sensitive. The sensitivity S is compared with two threshold values S1 and S2, and
the presence of analyte on the probe A is signaled if S is greater than S1,
the presence of analyte on the probe B is signaled if S is less than S2,
an uncertainty as to the presence or absence of analyte is signaled if S is between S1 and S2.

In a mode of implementation of the method, the power of the first-order diffracted beam, P₁, respectively P₁ₐ, is normalized, while it is being measured, by the power of an incident beam P_{inc}, respectively P_{inca}, measured before, respectively after, the sensitization step.

Preferably, to improve the sensitivity of a device associated with the method, the diffractive system is designed so that:
a period p of the periodic geometric pattern is from λ to 2λ, λ corresponding to an illumination wavelength of the diffractive system;
a fill rate r, defining a ratio between a width of the area of the periodic geometric pattern comprising the probe A and the period p, is less than or equal to 0.5;
an area of a periodic geometric pattern of the diffractive system (2) comprising a probe is realized by a bonding layer of the analyte, called specific layer (25), with a thickness eₛ and comprising the probe and an anchor layer of the probe, called bonding layer (26), with a thickness e_{c}.

In addition to improving the sensitivity of the device associated with the method, choosing the period of the geometric pattern between λ and 2λ allows only one first-order diffracted beam to be obtained, which is, furthermore, at a high angular separation of the zero-order. In an example of realization, for a diffractive system period of substantially 1 μm, and for a wavelength of 633 nm, the angle β₁ is substantially 40°.

Preferably, the bonding layer is made such that the thickness e_{c} is between 0 and 500 nm.

Preferably, the specific layer is realized such that a ratio

$$\frac{{e}_{s}}{{e}_{analyte}}$$

is less than 1, where e_{analyte} is a thickness of an analyte layer deposited on the probe, after the sensitization step.

In one mode of implementation of the method according to the invention, steps b) and c) are performed simultaneously.

In an implementation example of the method, the diffractive system is realized in a material capable of reflecting an incident beam.

In another implementation example of the method, the diffractive system is realized in a material capable of transmitting an incident beam.

Preferably, the diffractive system is illuminated by a collimated monochromatic source, e.g. a laser, at a wavelength λ selected in the visible and infrared spectra.

The invention also relates to a diffractive system for the implementation of the method and comprising a geometric pattern, comprising at least one probe, on a substrate.

Preferably, the substrate is flat and is realized for example in a material such as glass, silicon or plastic.

The invention also relates to a device for seeking the presence of an analyte bound to a probe forming a diffractive system which comprises means of illumination the diffractive system using a coherent incident beam. The device also comprises:
means of measuring the power of the first-order diffracted beam, after diffraction of the incident beam by said diffractive system;
means for calculating a relative variation of signal, called sensitivity S, by comparing, within a single diffractive system, the power measurement of the first-order diffracted beam before and after a sensitization step, i.e. a step during which a probe is temporarily brought into contact with a medium likely to contain an analyte and during which the possible analyte binds to the probe,
means of presenting the information that characterizes the sensitivity S.

The invention also relates to an analysis chip comprising a plurality of diffractive systems, comprising at least one probe, juxtaposed onto a surface of a base.

In one embodiment, the analysis chip comprises at least two diffractive systems that differ in their different periodic geometric patterns and/or by at least one of their probes.

The detailed description of the invention refers to the figures showing, as follows:

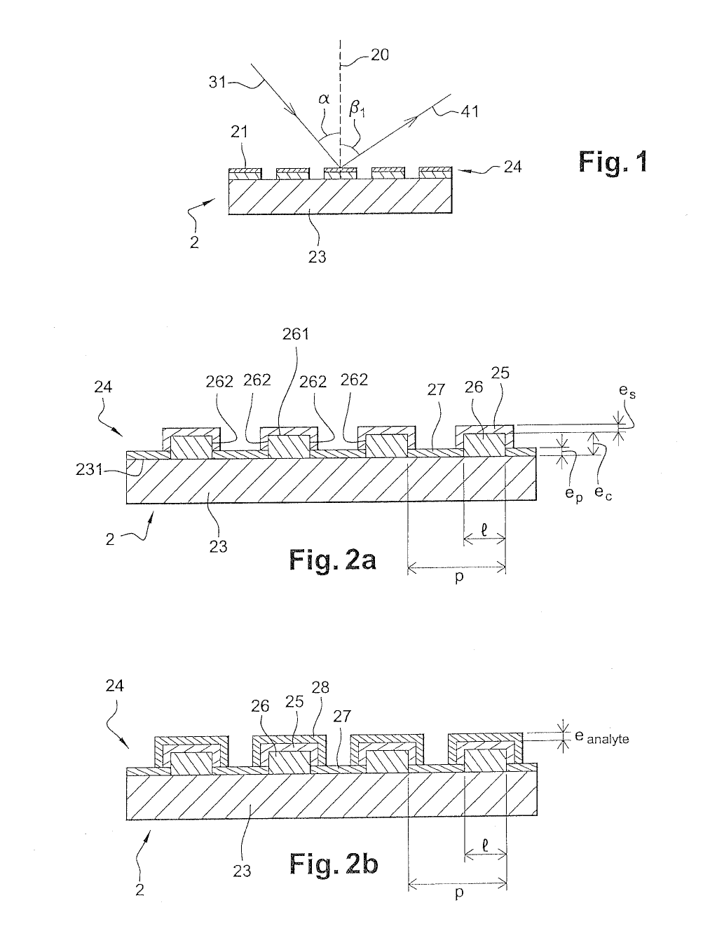

FIG. 1 illustrates the principle of diffraction on a grating;

FIG. 2a, a cross section of a diffractive system according to the invention before a sensitization step;

FIG. 2b, a cross section of a diffractive system according to the invention after the sensitization step;

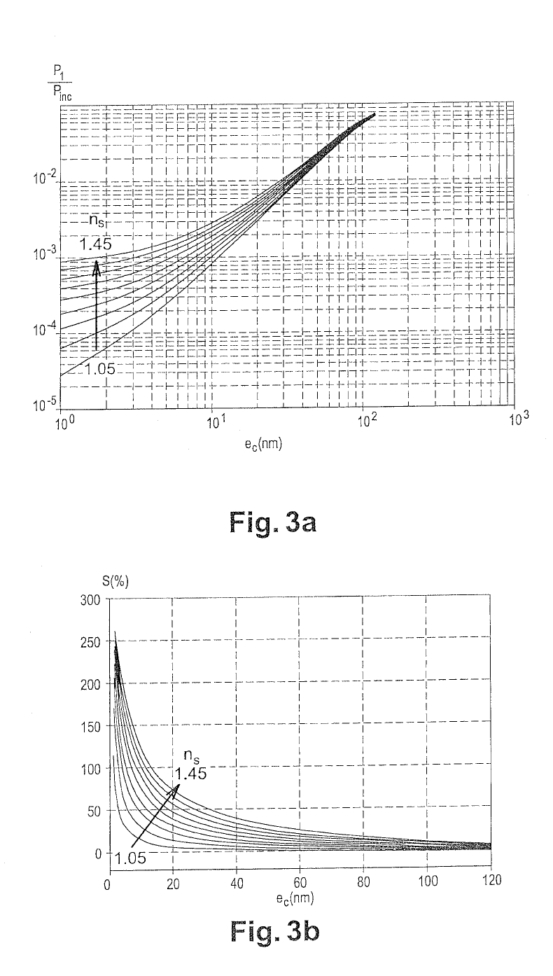

FIG. 3a, an illustration of a power of the diffracted beam as a function of a thickness e_{c} of a bonding layer of the diffractive system according to the invention, for different indices of a probe;

FIG. 3b, an illustration of a sensitivity as a function of a thickness e_{c} of the bonding layer of the diffractive system according to the invention, for different indices of the probe;

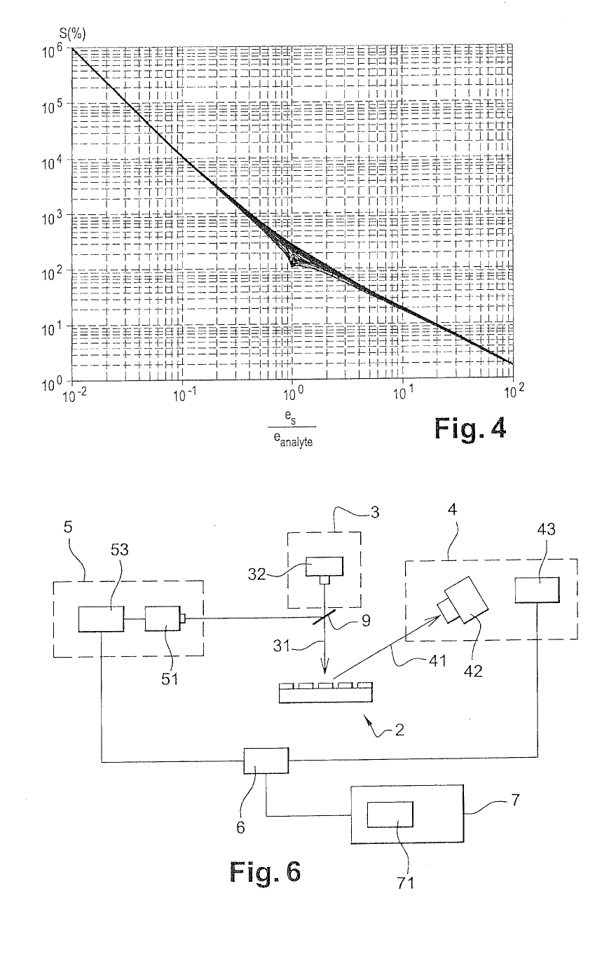

FIG. 4, an illustration of the sensitivity as a function of a ratio of a thickness eₛ of a specific layer comprising a probe and a thickness of an analyte e_{analyte} according to the invention;

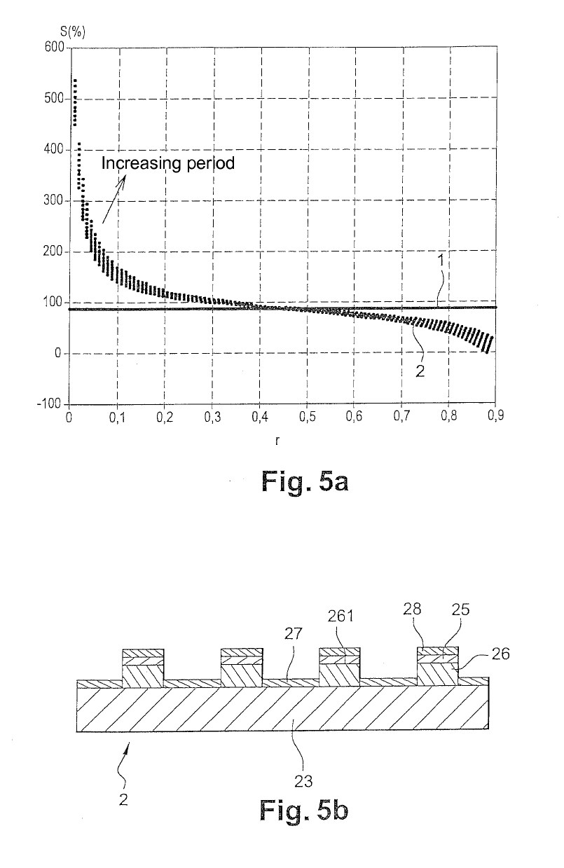

FIG. 5a, an illustration of the sensitivity as a function of a fill rate according to the invention;

FIG. 5b, a cross section of the diffractive system illustrating a first example of the analyte bonding onto the probe;

FIG. 6, a schematic view of a measuring device for seeking an analyte according to the invention;

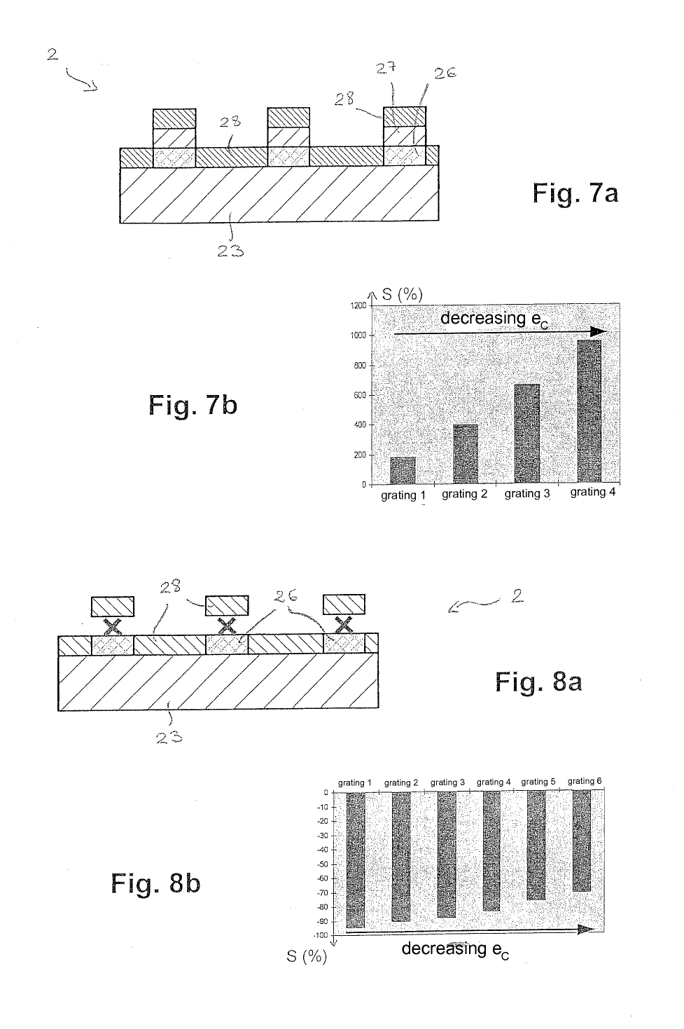

FIG. 7a, a schematic illustration of a diffractive system realized experimentally, after the sensitization step;

FIG. 7b, an illustration of the sensitivity as a function of the thickness of the bonding layer of the diffractive system of FIG. 7a;

FIG. 8a, a schematic illustration of a diffractive system realized experimentally, after the sensitization step;

FIG. 8b, an illustration of the sensitivity as a function of the thickness of the bonding layer of the diffractive system of FIG. 8a.

The method according to the invention consists of seeking the presence of an analyte likely to be contained in a medium, using a receiver material, called probe, forming a diffractive system.

“Analyte” means a material to be detected.

Analytes that can be detected include, but are not limited to, for example:
a biological material such as bacteria, yeasts, antibodies, sugars, peptides, volatile organic compounds;
a chemical or biochemical material, such as pesticides, sugars, deoxyribonucleic acid (DNA), pharmaceuticals molecules;

“Probe” means a complement specific to the analyte, a material having an affinity with the analyte, capable of specifically binding to the analyte. This material is, for example:
a biological material such as cells or microorganisms such as bacteria;
a chemical or biochemical material, such as molecules, for example silanes, biomolecules such as oligonucleotides, deoxyribonucleic acid (DNA), plasmids, proteins, antibodies, oligosaccharides, polysaccharides;
a synthetic material, such as for example a molecularly imprinted polymer (MIP);
a bistable material such as, for example Prussian blue analogues, iron-based coordination polymers, e.g. (Fe^{II} (pyrazine) (Pt (CN)₄)).

According to the method, as illustrated in FIG. 1, the diffractive system 2, comprising a probe, called probe A, is illuminated by a coherent incident beam 31 with wavelength λ. The diffractive system 2 is formed by a periodic geometric pattern 24, with alternating areas in relief, comprising the probe A, and areas not comprising the probe A, deposited on a substrate 23 and likely to contain an analyte bound to the probe A.

The incident beam 31 makes an angle α with a normal 20 to a diffractive surface 21 of the diffractive system 2.

The coherent incident beam 31 interacts with the diffractive system 2 that generates diffracted beams 41, forming angles βᵢ with the normal 20, each angle βᵢ corresponding to an i^{th} diffraction order of the diffraction field produced by the diffractive system 2. (In FIG. 1, for example, only the first-order diffracted beam, with a β₁ angle, is shown).

The diffracted beams are measured by measuring means (not shown) that deliver a value of a measured power of each diffracted beam. The measured power of each diffracted beam decreases as the diffracted order increases.

The diffraction field obtained after diffracting the incident beam on the diffractive system depends, among others, on the geometric characteristics of the diffractive system, said geometric characteristics being variable depending on the presence or absence of the analyte on the probe of the diffractive system 2.

According to the method, in a first step, a first measurement of a power P₁ of the first-order diffracted beam is realized, when the diffractive system has not yet been subjected to the presence of the analyte likely to bind to the probe.

In a second step, called sensitization step, the probe A is temporarily brought into contact with a medium likely of containing the analyte. During that sensitization step, the possible analyte binds to the probe A.

The sensitization step is performed in a conventional manner and not described here, e.g. by immersing the diffractive system into a medium or by depositing the medium onto the probe, for example by a micropipette, and drying.

In a third step, a measurement of a value of a power P₁ₐ of the first-order diffracted beam is realized, using the diffractive system obtained after the sensitization step.

During this third step, the diffractive system 2 is again subjected to the same incident coherent beam 31, with the same angle α to the normal 20.

In a particular mode of implementation of the method according to the invention, when the second step—the sensitization step—consists of immersing the probe in a liquid, said second and third steps can be performed simultaneously without changing the outcome of said steps.

In a fourth step, the two power measurement values P₁ and P₁ₐ are compared to infer the presence or absence of the analyte on the diffractive system, and hence its presence in the medium.

The two power values are compared so as to determine a relative variation of the signal (algebraic value), called sensitivity S, such that:

$$S = \frac{{P}_{1} - {P}_{1 a}}{{P}_{1}} \qquad ( 1 )$$

From the above expression, threshold values S₁ and S₂ are determined such that:
when S>S₁, the analyte is deemed to be present on the probe A,
when S<S₂, the analyte is deemed to be absent on the probe A,
when S₂<S<S₁, there is an uncertainty that does not allow the presence or absence of the analyte on the probe A to be determined. In this last case, new measurements should be performed, amending the operating protocol if necessary.

In a particular mode of implementation of the invention, those areas of the periodic geometric pattern that do not comprise the probe A essentially comprise a probe B.

Said probe B is sensitive to an analyte to which the probe A is not sensitive.

The method according to the invention allows seeking the presence of one of the two analytes, likely to be contained in the medium.

The detection of the two analytes is realized from one single diffracted beam, the first-order diffracted beam.

The detection between the two distinct analytes is called differential.

The sensitivity S is still defined by the expression (1).

The threshold values S₁ and S₂ are determined such that:
when S>S₁, the analyte is deemed to be present on the probe A,
when S<S₂, the analyte is deemed to be present on the probe B,
when S₂<S<Sₜ there is an uncertainty that does not allow the presence or absence of analyte on either the probe A or the probe B to be determined. In this last case, new measurements should be performed, amending the operating protocol if necessary.

The threshold values S₁ and S₂ can be determined experimentally, given the large number of parameters, such as, for example, the geometric characteristics of the diffractive system, the wavelength of the incident beam, the angle of incidence, the shape of the incident beam, the substrate index, the substrate roughness, all of which affect the accuracy of the measurement.

Preferably, the threshold value S₁ is substantially equal to 5% and the threshold value S₂ is substantially equal to −5%.

Power fluctuations in the emitted incident beam can lead to additional uncertainty, taking into account the offset in time of the diffracted beam power measurements, before and after the sensitization step.

A means implemented by the method to compensate said fluctuations is to normalize each measured power value P₁, P₁ₐ of the first-order diffracted beams in relation to a value of measured power P_{inc}, P_{inca} of the incident beam at the time of each measurement, before and after the sensitization step. To realize a measurement of the power of the incident beam simultaneously with the measurement of the power of the diffracted beam, a portion y of the incident beam's power is collected, 10 to 20% for example, so as not to reduce too much the sensitivity of the measuring device associated with the method.

Thus, the sensitivity S is expressed as:

$$S = \frac{\frac{{P}_{1}}{γ \cdot {P}_{inc}} - \frac{{P}_{1 a}}{γ \cdot {P}_{inca}}}{\frac{{P}_{1}}{γ \cdot {P}_{inc}}} \qquad ( 2 )$$

The angle values of the diffracted beams, too close to the normal 20 or to each other, can lead to a difficult implementation of the method.

A means employed by the method to generate more open diffracted beam angles consists of using a diffractive system with a period p ranging from λ to 2λ, preferably 1 μm, given the wavelengths used, which preferably range from 400 nm to 1200 nm.

Preferably, if the incident beam 31 is, in addition, emitted at normal incidence (α=0) relative to the diffractive system 2, only the first-order diffracted beam is visible. The angle β₁ of the first-order diffracted beam is sufficiently open (e.g. for a period of the diffractive system of substantially 1 μm, and for a wavelength of 633 nm, the angle β₁ is substantially 40°) to allow an angular and spatial decoupling of the reflected and diffracted beams.

By obtaining only the first-order diffracted beam, the maximum diffracted power is located on the first-order diffracted beam 1, which improves the signal to noise ratio.

In addition, variations in the geometric characteristics of the diffractive system after the sensitization step, consistent with the presence of the analyte on the probe, are reflected only at the level of the power of the first-order beam, and are not dispersed over several higher order beams.

A diffractive system 2 for implementing the method comprises, as shown in FIG. 2a, the periodic geometric pattern 24, formed by alternating areas in relief, comprising the probe A, and areas not comprising the probe A, deposited on a surface 231 of the substrate 23, with an index of n_{sub}.

The diffractive system is described in detail in the case of a grating of parallel lines 24, in relief, comprising the probe A. This choice is non-limiting and other diffractive systems comprising periodic geometric patterns, such as a 2D grating, e.g. a grid, or a complex geometric figure able to diffract light, can also be used.

Preferably, to increase the sensitivity of the method, the grating lines are on a nanoscale.

In a preferred embodiment, as shown in FIGS. 1 to 2b, the substrate 23 has a flat surface 231.

The substrate 23 is, for example, made of a glass, silicon or gold material.

Preferably, the lines, comprising the probe A, have a crenelated cross section. But other cross sections are also possible, such as for example sinusoidal or triangular cross sections.

The grating has the period p as defined above, a line width l, a fill rate r, defined as a ratio between the line width l and the period p,

$$r = \frac{l}{p} .$$

The fill rate r is a compromise between the sensitivity S and the power of the diffracted beam. If the fill rate r decreases, the sensitivity S increases but the power of the diffracted beam decreases, making the power measurement more difficult to achieve.

Preferably, to improve the sensitivity S of the method while maintaining a sufficient value of the power of the diffracted beam, the grating is dimensioned such that the fill rate r is less than 0.5.

The parallel lines in relief 24 comprise a first layer, called bonding layer 26 with a thickness of e_{c} and an index of n_{c}.

The adhesive layer comprises a material capable of allowing the anchoring of the probe A.

To improve the sensitivity S of the device, the material of the bonding layer 26 is chosen so as to allow surface bonding of the probe A onto the bonding layer. “Surface bonding” means bonding onto an upper surface 261 of the bonding layer, opposite the substrate 23, as well as on lateral surfaces 262 of said bonding layer.

This material is, for example:
a silane, if the substrate is silicon,
a thiol, if the substrate is gold,
a sugar,
a dendrimer,
a metallic nano-island,
a nanoparticle,
an MIP,
a bistable material.

The thickness e_{c} of the adhesive layer is a compromise between the sensitivity S and the power of the diffracted beam. As the thickness e_{c} increases, so the diffracted beam power increases, but the sensitivity S decreases.

Advantageously, the thickness e_{c} ranges from 0 nm and 500 nm, preferably substantially of the order of 5 nm.

The parallel lines in relief 24 comprise a second layer with a thickness of eₛ and an index of nₛ, called specific layer 25, for bonding the analyte, which comprises the probe A.

The thickness eₛ is dimensioned relative to a thickness e_{analyte} of an analyte layer 28 (FIG. 2b), likely to have been deposited onto the specific layer 25 after the sensitization step. A ratio

$$\frac{{e}_{s}}{{e}_{analyte}}$$

is a compromise between the sensitivity S and the power of the diffracted beam. If the ratio

$$\frac{{e}_{s}}{{e}_{analyte}}$$

decreases, the sensitivity S increases but the power of the diffracted beam decreases.

Preferably, to improve the sensitivity S of the device while maintaining a sufficient value of the power of the diffracted beam, the thickness eₛ of the specific layer is dimensioned such that the ratio

$$\frac{{e}_{s}}{{e}_{analyte}}$$

is less than 1.

Advantageously, the thickness eₛ of the specific layer 25 ranges from 0.5 nm and 150 nm, preferably substantially of the order of 10 nm.

In a first embodiment, as shown in FIGS. 2a and 2b, the grating 2 comprises, between the parallel lines 24, a layer covering the substrate 23, called passivation layer 27, with a thickness of eₚ. Said passivation layer comprises a material capable of increasing the adhesion selectivity of the probe with the analyte. By increasing the adhesion selectivity of the probe with the analyte, the sensitivity of the device is improved.

In an example of realization, the passivation layer is a polyethylene glycol (PEG), a bovine serum albumin (BSA), an octadecyltrichlorosilane (OTS), an ethanolamine.

The thickness eₚ of the passivation layer is small compared to the thickness e_{c} of the bonding layer, e.g. of the order of a few angstroms, in order not to decrease the bonding layer's bonding surface.

In an more complex embodiment, not illustrated, the grating 2 comprises, between the parallel lines 24, a layer covering the substrate, called second specific layer, to bond an analyte for which the probe A is not sensitive, and comprising the probe B and an anchor layer of the probe B.

Preferably, in order to efficiently use the differential detection between the two analytes, the thickness e_{analyte} of the analyte layer 28 deposited onto the probe A has a thickness at least less than one nanometer or at least greater by one nanometer than the thickness of an analyte layer deposited onto the probe B.

Advantageously, in this embodiment, the fill rate r is substantially equal to 0.5.

In one embodiment, the grating of lines is a grating of lines by reflection and the substrate is, preferably, optically transparent to the wavelength λ used.

In another embodiment, the grating of lines is a grating of lines by reflection and the substrate is, preferably, not optically transparent to the wavelength λ used.

### EXAMPLE 1

### Bonding Layer Thickness e_{c} Simulation

Example 1 illustrates, from FIGS. 3a and 3b, the compromise between the sensitivity S and the normalized power of the first-order diffracted beam

$$\frac{{P}_{1}}{{P}_{inc}}$$

before the sensitization step, for different thicknesses e_{c} of the bonding layer 26 and for the following parameters:

| λ | 633 nm | α | 0° |
|---|---|---|---|
| n_{sub} substrate | 1.45 | | |
| index | | | |
| n_{c} bonding layer | 1.5 | bonding layer | 0.5 to |
| index | | thickness e_{c} | 120 nm |
| nₛ probe A | 1.05 to 1.45 | probe A | 10 nm |
| index | | thickness e_{c} | |

Whatever the nₛ index of the probe A, when the thickness e_{c} of the bonding layer increases, the normalized power of the first-order diffracted beam

$$\frac{{P}_{1}}{{P}_{inc}}$$

before the sensitization step increases (FIG. 3a) unlike the sensitivity S, which decreases rapidly (FIG. 3b.)

### EXAMPLE 2

### Simulation of the Sensitivity S as a Function of the Ratio

$$\frac{{e}_{s}}{{e}_{analyte}}$$

Example 2 illustrates, from FIG. 4, the sensitivity S as a function of the ratio

$$\frac{{e}_{s}}{{e}_{analyte}}$$

of the diffractive system, for different thicknesses eₛ of the specific layer and for the following parameters:

| λ | 633 nm | α | 0° |
|---|---|---|---|
| n_{sub} substrate | 1.45 | | |
| index | | | |
| n_{c} bonding layer | 1.5 | bonding layer | 0 nm |
| index | | thickness e_{c} | |
| nₛ probe A index | 1.3 | probe A thickness e_{c} | 0.5 to 100 nm |
| n_{analyte} index of | 1.3 | e_{analyte} thickness | 0.5 to 100 nm |
| the analyte | | of the analyte | |

The different curves show the same profile and it can be seen that the sensitivity S is improved if the ratio

$$\frac{{e}_{s}}{{e}_{analyte}}$$

is less than 1.

### EXAMPLE 3

### Fill Rate r and Sensitivity S Simulation

Example 3 illustrates, from FIG. 5a, the sensitivity S as a function of the fill rate of the diffractive system for different periods p and for the following parameters:

| λ | 633 nm | α | 0° |
|---|---|---|---|
| n_{sub} substrate | 1.45 | fill rate r | 0.01 to 0.85 |
| index | | | |
| n_{c} bonding layer | 1.5 | bonding layer | 14 nm |
| index | | thickness e_{c} | |
| nₛ probe A index | 1.35 | probe A thickness e_{c} | 10 nm |
| n_{analyte} index | 1.35 | e_{analyte} thickness | 10 nm |
| of the analyte | | of the analyte | |
| period p | 700 to | | |
| | 1200 nm | | |

Curve 1 illustrates the case in which the bonding of the probe A onto the bonding layer is realized only on the upper portion of said bonding layer (as shown in FIG. 5b). It can be seen that the sensitivity S remains constant, whatever the fill rate and the period of the diffractive system.

Curve 2 illustrates the case in which the bonding of the probe A onto the bonding layer is realized over the entire area (the upper part and the lateral surfaces) of said bonding layer (as shown in FIG. 2b). It can be seen that the sensitivity S is improved if the fill rate r is less than 0.5, whatever the period p of the diffractive system.

### EXAMPLE 4

### Experimental Measurement of the Sensitivity S

Example 4 illustrates, from FIGS. 7a and 7b, the sensitivity S obtained experimentally for several thicknesses of the bonding layer and for the following Parameters:

| λ | 632 nm | α | 0° |
|---|---|---|---|
| n_{sub} substrate | 1.52 | fill rate r | 0.5 |
| index | | | |
| n_{c} bonding layer | 1.41 | bonding layer | 2.5 to 1.5 nm |
| index | | thickness e_{c} | |
| nₛ probe A index | 1.35 | probe A thickness e_{c} | 1 nm |
| period p | 1 μm | Laser power | 5 mW |

For this example 4, the substrate is a silanized glass. The bonding layer is a streptavidin layer. The probe A is a biotinylated protein A. The analyte is an anti-protein A antibody.

The angle of the first-order diffracted beam is 40°.

FIG. 7a illustrates schematically the diffractive system realized for the implementation of the method. The diffractive system has a period of 1000 nm and is composed of 400 lines, each of which is 500 nm in width. The first step to realize the diffractive system consists of depositing the bonding layer 26 by molecular buffering. The second step is to incubate the probe molecule, followed by rinsing with a phosphate buffered saline, called PBS buffer. The last step is to incubate the analyte followed by a rinse with a PBS buffer.

Two interactions are observed:
a first interaction between the analyte and the probe A (specific interaction),
a second interaction between the analyte and the substrate.

FIG. 7b illustrates the sensitivity obtained for four gratings with different thicknesses e_{c}, different from the bonding layer (the thickness varies from 1.5 nm to 2.5 nm).

It can be seen that, as in the simulations (FIG. 3b), when the thickness e_{c} of the bonding layer decreases, the sensitivity S increases. In addition, the sensitivity S is positive.

### EXAMPLE 5

### Experimental Measurement of the Sensitivity S

Example 5 illustrates, from FIGS. 8a and 8b, the sensitivity S obtained experimentally for several thicknesses of the bonding layer and for the following parameters:

| λ | 632 nm | α | 0° |
|---|---|---|---|
| n_{sub} substrate | 1.52 | fill rate r | 0.5 |
| index | | | |
| n_{c} bonding | 1.41 | bonding layer | 2.5 to 1.5 nm |
| layer index | | thickness e_{c} | |
| | | probe A thickness e_{c} | |
| period p | 1 μm | Laser power | 5 mW |

For this example 5, the substrate is a silanized glass. The bonding layer is a streptavidin layer. The analyte is an anti-protein A antibody.

The angle of the first-order diffracted beam is 40°.

FIG. 8a illustrates schematically the diffractive system realized for the implementation of the method. The diffractive system has a period of 1000 nm and is composed of 400 lines, each of which is 500 nm in width. The first step to realize the diffractive system consists of depositing the bonding layer 26 by molecular buffering. The second step is to incubate the analyte followed by a rinse with a PBS buffer. There was no step of incubation of the probe molecule.

Two interactions are observed:
a first interaction between the analyte and the bonding layer,
a second interaction between the analyte and the substrate.

FIG. 8b illustrates the sensitivity obtained for six gratings with different thicknesses e_{c}, different from the bonding layer (the thickness varies from 1.5 nm to 2.5 nm).

It can be seen that the sensitivity S is negative. Indeed, the interaction between the analyte and the bonding layer is substantially nonexistent. The interaction between the analyte and the substrate is then predominantly observed. Thus, when there is no interaction between the lines and the analyte, the sensitivity S is negative.

This example shows that it is possible to measure two interactions with one measurement.

A measuring device 1 for seeking an analyte in a medium likely to contain it, as shown in FIG. 6, said analyte being bound to a probe forming a diffractive system 2, comprises:
means of illuminating the diffractive system 2 with the coherent incident beam 31,
means of measuring 5 the power of the first-order diffracted beam 31,
means of measuring 4 the power of the first-order diffracted beam 41, after diffraction of the incident beam 31 by the diffractive system 2,
means of calculating 6 the sensitivity S,
means 7 of presenting the information.

When the diffractive system 2 is realized with the period p of the periodic geometric pattern ranging between λ and 2λ, such that only the first-order diffraction beam is visible, there is no need to use any optical splitter, such as for example a prism, to separate the diffracted beams. The measuring device thus gains in both cost and simplicity of realization.

The illumination means 3 comprise a light source 32.

Advantageously the wavelength λ of the light source is within the visible and infrared range.

In an example of realization, the wavelength λ of the light source is substantially of the order of 633 nm.

In an example of realization, the light source 32 is a continuous or pulsed monochromatic source.

Preferably, the light source 32 is a laser, such as for example a laser diode or a Helium-Neon laser.

In an example of realization, the light source 32 is a white light. The illumination means 3 also comprise at least one selection filter (not shown) of the desired wavelength and collimating optics (not shown) to generate the collimated incident beam.

The measuring means 4, 5 comprise at least one detector 42, 51, a detector 51 intercepting the incident beam, for example using a semi-reflecting mirror 9, and a detector 42 intercepting the first-order diffracted beam.

Each detector 42, 51 is connected to processing means 43, 53 capable of processing a measurement signal transmitted by the detector. The processing means 53 deliver the value of the power of the incident beam and the processing means 43 deliver a value of the power of the first-order diffracted beam.

The detectors are, for example, a photosensitive element, such as a photodiode or at least one photomultiplier or a charge-coupled device (CCD).

In an example of realization, the beams are directed through a waveguide, such as for example an optical fiber, to the detector.

In one embodiment, a single measurement means provides the function of the two measurement means 4, 5 by measuring the power of the incident beam and the power of the diffracted beam.

The computation means 6 are connected to the measuring means 4 and 5 and determine the value of the sensitivity S.

For example, the computation means comprise at least one computer capable of calculating the sensitivity S.

The information presentation means 7 are connected to the computation means 6 and characterize, among others, the sensitivity S.

The information presentation means 7 comprise for example display means 71, which report the presence, absence or uncertainty about the presence of the analyte.

In an example of realization, when the diffractive system comprises the probe A, the display means 71 are a set of three diodes, flashing or not, that light up depending on the value of the sensitivity S:
the green diode to indicate the presence of the analyte on the probe A,
the red diode to indicate the absence of the analyte on the probe A,
the yellow diode to indicate the uncertainty about the presence or absence of the analyte.

When the diffractive system comprises the probe A and the probe B, the display means 71 are a set of three diodes, flashing or not, that light up depending on the value of the sensitivity S:
the green diode to indicate the presence of analyte on the probe A,
the red diode to indicate the presence of analyte on the probe B,
the yellow diode to indicate the uncertainty about the presence or absence of analyte on either the probe A or the probe B.

Preferably, the information presentation means 7 further comprise an indicator of the quality of the diffraction indicating a signal to noise ratio before the sensitization step.

In another example of realization, the display means 71 are an image of the diffractive system, color-coded according to the intensity of the diffracted beam, such as for example a blue color whose intensity increases with the intensity of the diffracted beam in the case where the sensitivity S is greater than Sₜ a red color whose intensity increases when the intensity of the diffracted beam decreases in the case where the sensitivity S is lower than S₂ and a black color in the case where the sensitivity is between S₁ and S₂.

In one embodiment of the invention, to allow analyses (seeking the presence of at least one analyte bound to probe) to be realized on a large number of diffractive systems in minimum time, an analysis chip comprises a plurality of diffractive systems juxtaposed onto a surface of a base, following specific arrangements, regular in general, such as for example in the form of matrices of rows and columns. Said diffractive systems are analyzed individually according to the method of the invention, for example by means of the measuring device described above, which sweeps successively the plurality of diffractive systems on the surface of the base, either by movement of the measuring device, or by movement of the base, or by a combination of both movements. Each diffractive system comprises at least one probe and has specific characteristics.

In a first example, for redundant measurements, the diffractive systems are identical.

In a second example, at least two diffractive systems differ in their periodic geometric patterns.

In a third example, to allow seeking the presence of different analytes, at least two diffractive systems differ in at least one of their probes. For example, a first diffractive system is realized with a probe bound to a first analyte and a second diffractive system is realized with a probe bound to a different analyte, and not sensitive to the first analyte. This third example is used, by appropriate selection of the probes, to multiply the number of analytes that can sought on a single chip.

In a fourth example, at least two diffractive systems differ firstly by their periodic geometric patterns and secondly by at least one of their probes.

Preferably, a map of the base comprising all of the diffractive systems is realized, each colored area on the map corresponding to a location of a diffractive system. In an example of realization, the color corresponds to a color code depending on the intensity of the diffracted beam, such as for example a blue color whose intensity increases with the intensity of the diffracted beam in the case where the sensitivity S is greater than S₁, a red color whose intensity increases when the intensity of the diffracted beam decreases in the case where the sensitivity S is lower than S₂ and a black color in the case where the sensitivity is between S₁ and S₂.

1. Method of seeking the presence of an analyte bound to a probe, wherein a periodic geometric pattern (24), constituting a diffractive system (2), is formed by alternating areas comprising a probe, called probe A, and areas not comprising the probe A, said diffractive system (2) being made to be diffractive before a sensitization step, i.e. a step during which a probe is temporarily brought into contact with a medium likely to contain an analyte and during which the possible analyte binds to the probe, the method comprises at least the following steps:
a) measurement of a power P₁ of a first-order diffracted beam of a diffraction field produced by the diffractive system, with the probe unsensitized,
b) sensitization of the probe A,
c) measurement of a power P₁ₐ of a first-order diffracted beam of a diffraction field produced by the diffractive system,
d) comparison of the measured powers P₁ and P₁ₐ, said steps being performed in the order listed, characterized in that the diffractive system (2) is realized such that the period p of a periodic geometric pattern is between λ and 2λ, λ corresponding to an illumination wavelength of the diffractive system, such that only the first-order diffracted beam is visible.

2. Method according to claim 1, wherein the comparison is performed by determining a relative variation of signal, called sensitivity S according to the expression
$$S = \frac{{P}_{1} - {P}_{1 a}}{{P}_{1}} .$$

3. Method according to claim 2, wherein the sensitivity S is compared with two threshold values S1 and S2, and wherein
i) the presence of the analyte on the probe A is signaled if S is greater than S1,
ii) the absence of the analyte on the probe A is signaled if S is less than S2,
iii) an uncertainty as to the presence or absence of the analyte on the probe A is signaled if S is between S1 and S2.

4. Method according to claim 2, wherein those areas of the periodic geometric pattern that do not comprise the probe A essentially comprise a probe B which is sensitive to an analyte to which the probe A is not sensitive, and wherein the sensitization step b) also performs the sensitization of the probe B.

5. Method according to claim 4, wherein the sensitivity S is compared with two threshold values S1 and S2, and wherein
i) the presence of analyte on the probe A is signaled if S is greater than S1,
ii) the presence of analyte on the probe B is signaled if S is less than S2,
iii) an uncertainty as to the presence or absence of analyte is signaled if S is between S1 and S2.

6. Method according to claim 1, wherein the power of the first-order diffracted beam, P₁, respectively P₁ₐ, is normalized, while it is being measured, by the power of an incident beam P_{inc}, respectively P_{inca}, measured before, respectively after, the sensitization step.

7. Method according to claim 1, wherein the diffractive system (2) is realized such that a fill rate r, defining a ratio between a width of the area of the periodic geometric pattern comprising the probe A and the period p, is less than or equal to 0.5.

8. Method according to claim 1, wherein an area of a periodic geometric pattern of the diffractive system (2), comprising a probe, is realized by a bonding layer of the analyte, called specific layer (25), with a thickness eₛ and comprising the probe and an anchor layer of the probe, called bonding layer (26), with a thickness e_{c}.

9. Method according to claim 8, wherein the bonding layer (26) is made such that the thickness e_{c} is between 0 and 500 nm.

10. Method according to claim 8, wherein the specific layer (25) is realized such that a ratio
$$\frac{{e}_{s}}{{e}_{analyte}}$$
is less than 1, where e_{analyte} is a thickness of an analyte layer deposited on the probe, after the sensitization step.

11. Method according to claim 1, wherein steps b) and c) are performed simultaneously.

12. Method according to claim 1, wherein the diffractive system (2) is realized in a material capable of reflecting an incident beam.

13. Method according to, wherein the diffractive system (2) is realized in a material capable of transmitting an incident beam.

14. Method according to, wherein the diffractive system (2) is illuminated by a collimated monochromatic source.

15. Method according to claim 1, wherein the diffractive system (2) is illuminated by a laser.

16. Method according to claim 1, wherein the diffractive (2) system is illuminated at a wavelength λ selected in the visible and infrared spectra.

17. Diffractive system (2) for implementing the method according to claim 1, comprising a geometric pattern (24), comprising at least one probe, on a substrate (23).

18. Device for seeking the presence of an analyte bound to a probe forming a diffractive system (2) in accordance with claim 17 which comprises means (3) of illuminating the diffractive system (2) using a coherent incident beam (31), characterized in that the device comprises:
means of measuring (4, 5) the power of the first-order diffracted beam (41), after diffraction of the incident beam by said diffractive system (2),
means (6) for calculating a relative variation of signal, called sensitivity S, by comparing, within a single diffractive system, the power measurement of the first-order diffracted beam before and after a sensitization step, i.e. a step during which a probe is temporarily brought into contact with a medium likely to contain an analyte and during which the possible analyte binds to the probe,
means (7) of presenting the information that characterizes the sensitivity S.

19. An analysis chip comprising a plurality of diffractive systems (2) in accordance with claim 17 juxtaposed onto a surface of a base.

20. Analysis chip according to claim 19 comprising at least two diffractive systems (2) that differ in their different periodic geometric patterns and/or by at least one of their probes.
